(19) United States
(12) Patent Application Publication
(10) Pub. No.: US 2003/0157827 A1
(43) Pub. Date: Aug. 21, 2003

(54) Dual insulation displacement connector assembly

(76) Inventor: Michael Chen, Keelung (TW)

Correspondence Address: BIRCH STEWART KOLASCH & BIRCH, PO BOX 747, FALLS CHURCH, VA, 22040-0747, US

(21) Appl. No.: 10/078,707

(22) Filed: Feb. 21, 2002

(51) Int. Cl. H01R 4/24; H01R 4/26; H01R 11/20

(52) U.S. Cl. 439/396

(57) ABSTRACT

An dual IDC pair assembly is designed to arrange the IDC terminals to have different gap distance. In other words, it is designed to have a distance between the IDC terminals in the same pair is less than a distance to the adjacent IDC terminal belonging to the other pair. The IDC terminal and the long axis of the terminal base has an acute angle. The IDC subassembly satisfies the category 6 standard of EIA/TIA and the volume is compacted without the cable connecting presser with special design.

### FIELD OF THE INVENTION

The invention relates to a dual insulation displacement connector (IDC) assembly, used to transmitting electronic signal in high speed, and more particularly, to an IDC assembly satisfying the standard of EIA/TIA category 6 with a reduced size.

### BACKGROUND OF THE INVENTION

Recently, it has been very common to transmit information through the network communication system, which has been also getting wider applications. Due to the request in network communication system for high transmitting efficiency, it not only needs the quality of connecting cable to be better and better, but also the connector between communication devices is requested to have higher and higher quality as the transmitting speed goes faster. In general, the actual network route for communication is formed by the transmission medium and the electric connector. The transmission medium can be a twisted pair cable, coaxial cable, optical fiber, etc. However, the foregoing network route for communication still has some drawbacks. This cause that the signal quality gets worse as the frequency of the network communication system increases. For example:

1. The near end cross talk (NEXT) occurs, when the adjacent two cables affect to each other, due to the electromagnetic interference, the cross talk occurs.

2. Impedance, the impedance of the transmission medium should be matched to the system, so that the signal can be efficiently transmitted.

3. Return loss, since the impedance of the transmission system is not continuous, a reflection occurs and then cause power loss.

4. Attenuation, when signals are communicate through the transmission medium, the distance causes attenuation of the signal intensity and signal power.

According to the standard proposed by U.S. Electronic Industries Association (EIA) and TIA, it has been considered by IEEE. Therefore, the standard of EIA/TIA 568 has be included into the 802.3u communication protocol, and the quality of all of the transmission medium and connector subassembly should be within the standard.

In addition, those products satisfying the standard are also categorized. Currently, the standard of Category 6 is gradually to be basic requirement. In view of this situation, the some related issues should be considered and solved.

The conventional dual IDC assembly is shown in FIG. 1. The IDC terminal 11 is parallel with the long axis of the base 12. In this manner, each pair of IDC terminal 11 would be interfered by the adjacent IDC terminal 11, causing a poor transmission quality. In order to solve this problem, the prior skills proposed some solution. For example, the SIEMON CO. uses a metal shielding structure as shown in FIG. 2A. The distance between four IDC pair ends 11 is increased, and each IDC terminal 11 is designed with a shielding structure 13. By the affection of the shielding structure between any two IDC terminals 11, the interference is reduced. However, the total volume of the whole IDC subassembly would be largely increased. Material and fabrication cost would be accordingly increased. In addition, the Panduit Corp. arranges the IDC terminals 11 in two rows and alternatively shifting. Any adjacent three IDC terminals 11 has about equal inter-distance. In this design, it allows the any adjacent two IDC terminals 11 to have better TT compensation, wherein each IDC terminal is divided into a tip (T) and a ring (R), the TT effect means the compensation effect between the different tips, as shown in FIG. 2B. However, this design would cause an increase of the total thickness for the whole IDC subassembly, and causing that it cannot be installed communication cables by the usual punch tool.

### OBJECT AND SUMMARY OF THE INVENTION

In order to solve the above problems, the invention provides a dual IDC assembly, which increases the compensation effect for improving the transmission quality, but also it is installed communication cables by the usual punch tool.

According to the dual IDC assembly of the invention, it includes several pairs of IDC terminals, and a terminal base. The IDC terminals is formed of dual piercing terminals, and the terminal base has several inserting holes for adapting the IDC terminals, respectively. The gap distance between each IDC pair terminal is reduced. In other words, the distance between two IDC terminals belonging to the same the same pair is less than a distance to the adjacent IDC terminal belonging to the different pair. This can cause the compensation effect for the IDC terminals in the same pair. At the same time, the IDC terminal is arranged to be plugged into the terminal base in a slant manner, so that IDC terminal in the same pair can be really closer. The thickness of the whole IDC subassembly still remains, and the usual cable connecting presser can be used for connecting the communication cable.

The detail descriptions and concepts of the invention associating with drawings are as follows.

### BRIEF DESCRIPTION OF THE DRAWINGS

FIG. 1 is a perspective view, schematically illustrating a conventional IDC subassembly.

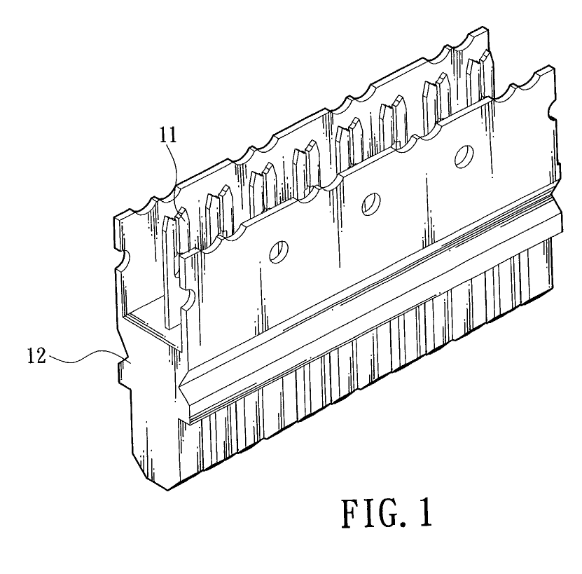

FIGS. 2A-2B are perspective view, schematically illustrating a prior art IDC subassembly.

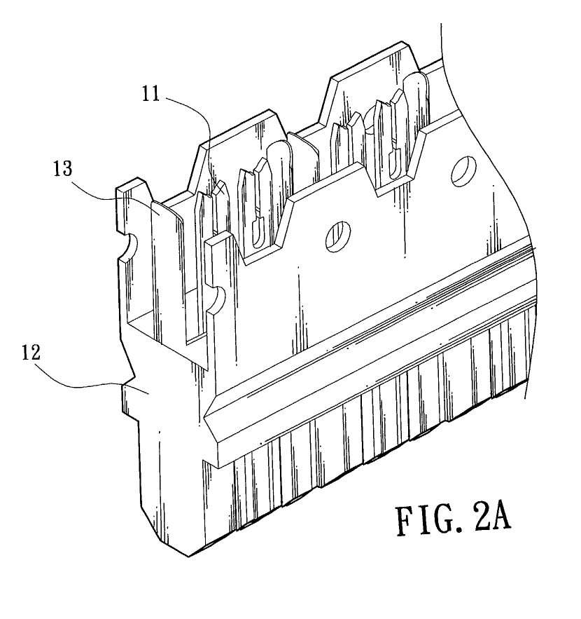

FIG. 3 is a drawing of the invention.

FIG. 4 is a top view of the IDC subassembly of the invention.

FIG. 5 is a bottom view of the IDC subassembly of the invention.

### DETAILED DESCRIPTION OF THE PREFERRED EMBODIMENTS

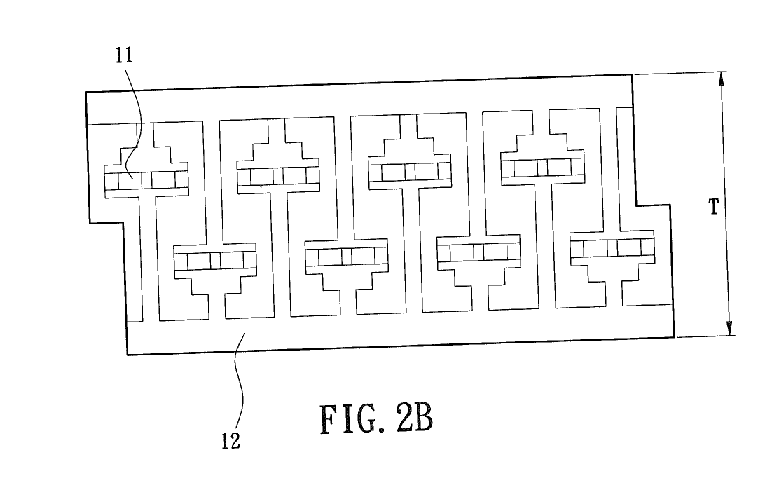

As shown in FIG. 3, the IDC assembly with dual IDC terminals, according to the invention, includes a terminal base 21 and several pairs of IDC terminals 22. In general, it has four pairs of IDC terminals 22. The embodiment takes four pairs as an example for descriptions. The terminal base 21 has the several grooves 211 for respectively being assembled with the IDC terminals 22. Each one of the IDC terminals 22 has two piercing terminals 222a, 222b. Also and, it has a stopping part 221 protruding from the side near at the central portion. When the IDC terminals is assembled into the groove 211 of the terminal base 21, it can be stop against the upper periphery of the groove 211, so as to prevent the IDC terminals 22 from piercing the groove 211 and dropping from the other end. At the same time, using the protruding point on the IDC terminals 22, it can be hooked on the terminal base 21. As a result, the IDC terminal 22 is firmly affixed.

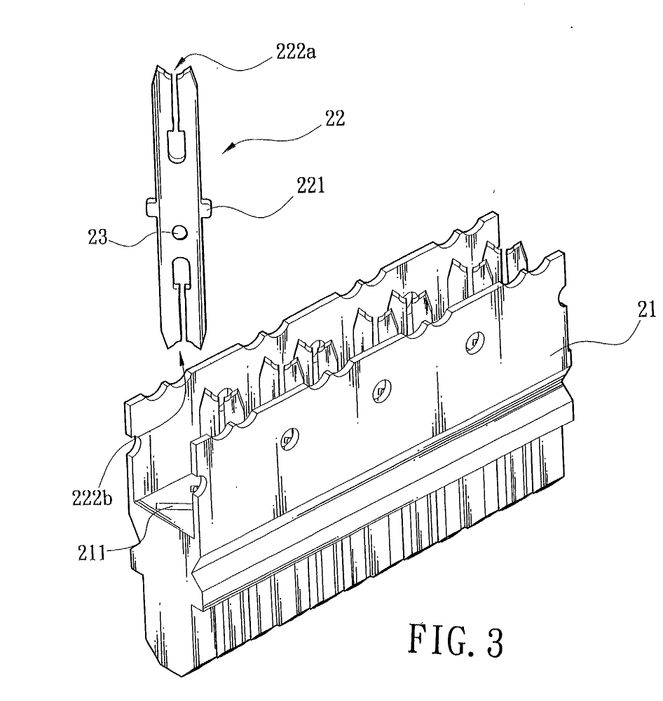

Simultaneously, as shown in FIG. 4, the distance T1 between the IDC terminals in the same pair is less than a distance T2 to the adjacent IDC terminal belonging to different pair. As a result, it can increase the capacitance effect between the IDC terminals in the same pair, so as to produce a TR compensation, wherein the IDC terminal of each pair includes a tip (T) and a ring (R), and the TR compensation effect is referring to the compensation effect between the tip and the ring. The transmission quality therefore is improved, and an inductance effect increases between the adjacent IDC terminal belonging the different pair, which can also be further compensate by the TT (RR) effect, wherein the IDC terminal for each pair includes a tip (T) and a ring (R), and the TT effect is referring to a compensation effect produced by the tips from the of IDC terminals for different pair, and the RR effect with the same principle. Moreover, the IDC terminal 22 is designed to have a slant plug-in manner. In other words, the IDC terminal 22 is not parallel to direction of the long axis C of the terminal base 21, but has a cute angle.

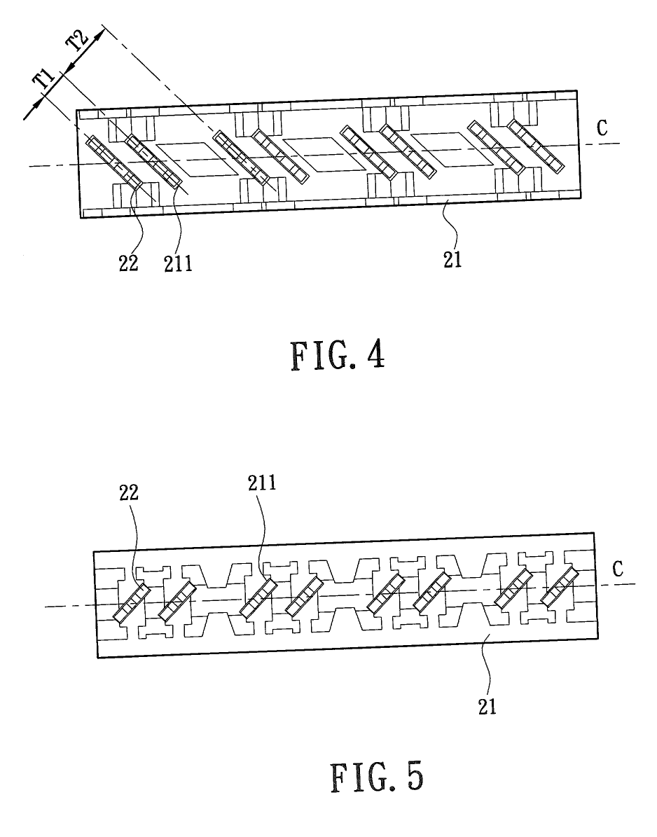

In addition, the IDC terminal takes the design of slant plug-in manner, whereby the width of the terminal base is reduced, and the thickness can still remain without necessary of increase. This allows the IDC subassembly to be assembled by using the conventional cable connecting presser. The invention is different from the conventional manner that needs a cable connecting presser with a special design to assemble. In addition, the design of slant plug-in manner allows the IDC terminal 22 and the long axis C of the terminal base to have a acute angle. This can be more convenient for assembling the lines of the communication cable, as shown in FIG. 5.

In summary, the invention is directed to a dual IDC assembly, using a slant plug-in design, so as to have an acute angle but not a right angle between the IDC terminal and the long axis of the terminal base. This allows the distance between the IDC terminals belonging to the same pair to be reduced, and the distance between the adjacent IDC terminals belonging to the different pair to be increased. This can produce the compensation effect and improve the transmission quality.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

I claim:

1. A dual insulation displacement connector (IDC) assembly, comprising a terminal base and a plurality pair of IDC terminals, the terminal base having a plurality of grooves for plugging in the IDC terminals, and each IDC terminal having two piercing terminals, said dual IDC assembly characterized by:
the distance of the IDC terminals in each pair is less than the distance to the adjacent one of the IDC terminals, and each one of the IDC terminals and the long axis of the terminal base forms an acute angle.

2. The dual IDC assembly of claim 1, wherein each of the IDC terminals are parallel.

3. The dual IDC assembly of claim 1, wherein the distance between the IDC terminals for each pair is the same.

4. The dual IDC assembly of claim 1, wherein the IDC terminal includes a protruding point, used to hook on a sidewall of the groove.

5. The dual IDC assembly of claim 1, wherein the IDC terminal includes a stopping part protruding from each sidewall of the IDC terminal, so as to stop against the groove and prevent the IDC terminal from dropping into the groove.
